(19) United States
(12) Patent Application Publication
(10) Pub. No.: US 2021/0316582 A1
(43) Pub. Date: Oct. 14, 2021

(54) LIFTING DEVICE

(71) Applicant: HITCH HOTEL, INC., Valencia, CA (US)

(72) Inventors: Geoff Patterson, Valencia, CA (US); Geremy Patterson, Valencia, CA (US); Grant Lee Nelson, Valencia, CA (US)

(21) Appl. No.: 17/272,202

(22) PCT Filed: Aug. 30, 2019
(86) PCT No.: PCT/US2019/049194

§ 371 Date: Feb. 26, 2021

Related U.S. Application Data
(60) Provisional application No. 62/726,143, filed on Aug. 31, 2018.

(51) Int. Cl. B60D 1/46; B60D 1/54; B60D 1/167

(52) U.S. Cl. CPC B60D 1/46; B60D 1/167; B60D 1/54

(57) ABSTRACT

A lifting device includes a base assembly, a hitch assembly coupled to the base assembly, a lift assembly movably coupled to the base assembly, and a trailer attachment assembly coupled to the lift assembly. The hitch attachment assembly is configured to connect to a hitch of a vehicle, and the trailer attachment assembly is configured to connect to a trailer. The base assembly includes a base frame and at least one guide extending upward from the base frame. The lift assembly includes a jack and at least one sleeve coupled to the jack. The sleeve of the lift assembly is in slidable engagement with the guide of the base assembly. Actuation of the jack is configured to raise or lower the lift assembly and the trailer attachment assembly relative to the base assembly and the hitch attachment assembly.

### CROSS-REFERENCE TO RELATED APPLICATION(S)

The present application claims priority to and the benefit of U.S. Provisional Application No. 62/726,143, filed Aug. 31, 2018, the entire contents of which are incorporated herein by reference.

### BACKGROUND

### 1. Field

The present disclosure relates generally to a lifting device configured to raise a trailer connected to a hitch of a vehicle.

### 2. Description of the Related Art

Automobile trailers, including storage and camping trailers, are typically hitched to an automobile for transport to a remote location, such as a camping site. Related art storage and camping trailers are typically large enough to fit one or more adult individuals, equipment, and food supplies. After hitching the trailer to the automobile, the driver may drive the trailer to the remote location. Some related art trailers require road-capable wheels for transport.

Additionally, some related art trailers may include legs configured to elevate the trailer off of the ground. In some related art trailers, these legs may be detachable or retractable. For instance, the legs may be retracted into a stowed configuration or detached during transportation to and from the remote site. However, with related art trailers including retractable or detachable legs, it may be difficult, cumbersome, and/or time-consuming to attach and detach the trailer from the hitch of the tow vehicle. For instance, with related art trailers, it may be difficult to raise the trailer off of the ground to enable retraction or detachment of the legs for transportation, and it may also be difficult to lower the trailer onto the ground after the legs have been deployed or attached once reaching the remote site.

### SUMMARY

The present disclosure is directed to various embodiments of a lifting device. In one embodiment, the lifting device includes a base assembly, a hitch assembly coupled to the base assembly, a lift assembly movably coupled to the base assembly, and a trailer attachment assembly coupled to the lift assembly. The hitch attachment assembly is configured to connect to a hitch of a vehicle, and the trailer attachment assembly is configured to connect to a trailer. The base assembly includes a base frame and at least one guide extending upward from the base frame. The lift assembly includes a jack and at least one sleeve coupled to the jack. The sleeve of the lift assembly is in slidable engagement with the guide of the base assembly. Actuation of the jack is configured to raise or lower the lift assembly and the trailer attachment assembly relative to the base assembly and the hitch attachment assembly.

The at least one guide may include a pair of guides on opposite sides of the jack, and the at least one sleeve may include a pair of sleeves in slidable engagement with the pair of guides.

The jack may be a manual screw-type jack, a hydraulic jack, a pneumatic jack, or an electromechanical jack.

The hitch attachment assembly may include a height adjustment mechanism.

The height adjustment mechanism may include a vertical post defining a first series of openings, a bracket configured to slide relative to the vertical post and defining a second series of openings configured to align with the first series of openings, and at least one fastener configured to extend through aligned openings of the first and second series of openings in the vertical post and the bracket.

The hitch attachment assembly may include a hitch bar.

The at least one guide of the base assembly may include at least one recess, and the at least one sleeve of the lift assembly may include at least one projection extending into the at least one recess.

The at least one sleeve of the lift assembly may include at least one recess, and the at least one guide of the base assembly may include at least at least one projection extending into the at least one recess.

The lift assembly may include a cross-member extending transversely, a vertical support member extending upward from an intermediate portion of the cross-member, and a bracket coupled to the vertical support member. The bracket supports a portion of the jack.

The bracket may be C-shaped, and the bracket may include at least one notch accommodating the portion of the jack.

The trailer attachment assembly may include a first axial member coupled to a first outer end of the cross-member, a first bracket coupled to the first axial member and defining at least one first opening, a second axial member coupled to a second outer end of the cross-member, and a second bracket coupled to the second axial member and defining at least one second opening. The first and second openings may be configured to receive fasteners securing the trailer attachment assembly to the trailer.

The base frame may include a cross-member and an axial member in a T-shaped configuration.

The base assembly may also include a platform at a joint between the axial member and the cross-member.

The at least one guide may include a first guide extending upward from a first end portion of the cross-member, and a second guide extending upward from a second end portion of the cross-member.

The present disclosure is also directed to various embodiments of a lifting device configured to raise and lower a trailer relative to a hitch of a tow vehicle to which the trailer is connected. In one embodiment, the lifting device includes a base assembly including a cross-member, an axial member coupled to the cross-member, a platform at a joint between the cross-member and the axial member, a first guide extending upward from a first end portion of the cross-member, and a second guide extending upward from a second end portion of the cross-member. The lifting device also includes a hitch attachment assembly including a hitch bar coupled to the base assembly, and a lift assembly movably coupled to the base assembly. The lift assembly includes a cross-member, a vertical support member extending upward from an intermediate portion of the cross-member, a jack coupled to the platform, a bracket coupled to the vertical support member and supporting the jack, a first sleeve coupled to the cross-member and in slidable engagement with the first guide, a second sleeve coupled to the cross-member and in slidable engagement with the second guide. The lift device also includes a trailer attachment assembly coupled to the cross-member of the lift assembly. Actuation of the jack is configured to raise or lower the lift assembly and the trailer attachment assembly relative to the base assembly and the hitch attachment assembly.

The jack may be a manual screw-type jack, a hydraulic jack, a pneumatic jack, or an electromechanical jack.

The hitch attachment assembly may include a height adjustment mechanism, and the hitch bar may be coupled to the height adjustment mechanism.

The height adjustment mechanism may include a vertical post defining a first series of openings, a bracket configured to slide relative to the vertical post that defines a second series of openings configured to align with the first series of openings, and at least one fastener configured to extend through aligned openings of the first and second series of openings in the vertical post and the bracket.

The trailer attachment assembly may include a first axial member coupled to a first outer end of the cross-member, a first bracket coupled to the first axial member that defines at least one first opening, a second axial member coupled to a second outer end of the cross-member, and a second bracket coupled to the second axial member that defines at least one second opening. The first and second openings may be configured to receive fasteners securing the trailer attachment assembly to the trailer.

This summary is provided to introduce a selection of features and concepts of embodiments of the present disclosure that are further described below in the detailed description. This summary is not intended to identify key or essential features of the claimed subject matter, nor is it intended to be used in limiting the scope of the claimed subject matter. One or more of the described features may be combined with one or more other described features to provide a workable device.

### BRIEF DESCRIPTION OF THE DRAWINGS

The features and advantages of embodiments of the present disclosure will become apparent by reference to the following detailed description when considered in conjunction with the following drawings. In the drawings, like reference numerals are used throughout the figures to reference like features and components. The figures are not necessarily drawn to scale.

FIGS. 1A-1D are a rear perspective view, a front perspective view, a right side view, and a left side view, respectively, of a lifting device according to one embodiment of the present disclosure; and

FIG. 2 depicts the embodiment of the lifting device illustrated in FIGS. 1A-1D coupled to a trailer.

### DETAILED DESCRIPTION

The present disclosure is directed to various embodiments of a lifting device. In one embodiment, one end of the lifting device may be configured to be connected to the hitch of a vehicle and another end of the lifting device may be configured to be connected to a trailer (e.g., an extendable trailer) towed by the vehicle. In one or more embodiments, the lifting device may be utilized to raise the trailer relative to the ground to enable the deployment and retraction of legs and/or wheels coupled to an underside of the trailer. For instance, in one or more embodiments, once the trailer has been towed to the desired location, the lifting device may be utilized to raise the trailer and then the legs and/or the wheels may be moved from a stowed position to a deployed position. The lifting device may then be utilized to lower the trailer until the legs and/or the wheels are supported on the ground. When a user desired to move the trailer, the lifting device may be utilized to sufficiently raise the trailer such that the legs and/or wheels may be returned to the stowed configuration. Once the legs and/or wheels of the trailer have been returned to the stowed configuration, the vehicle may be utilized to tow the trailer to the desired location. In one or more embodiments, the lifting device may be utilized to raise any other device or any other component of the device.

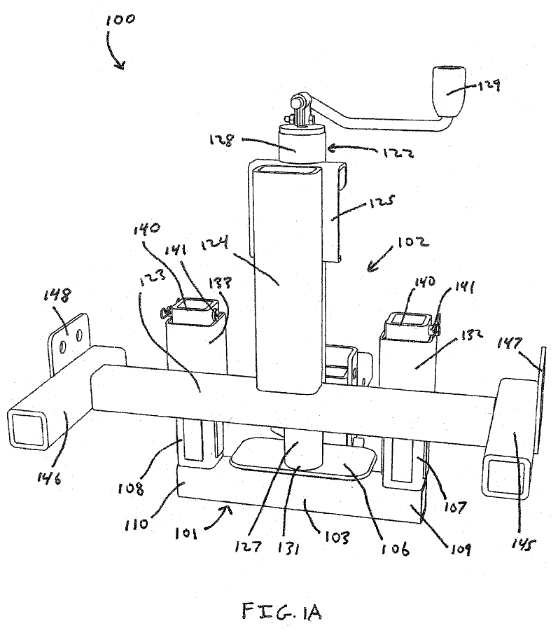

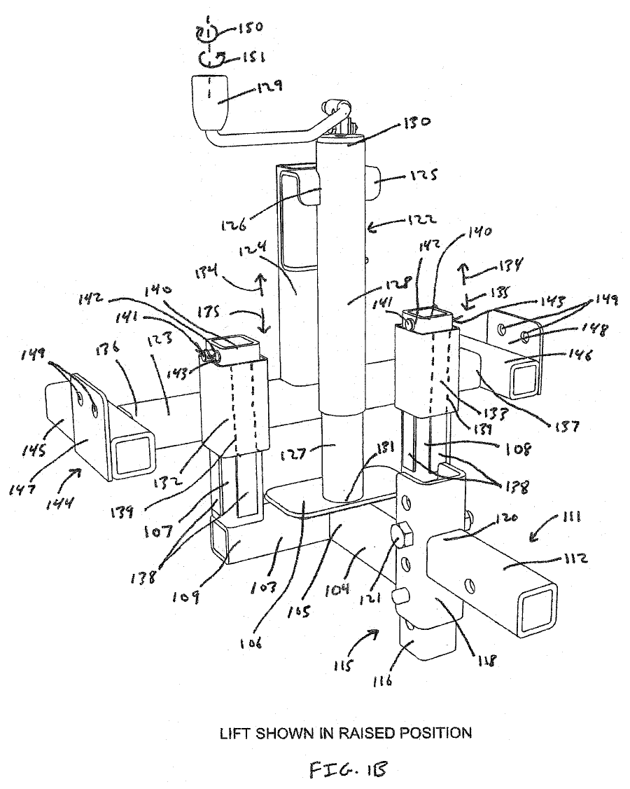

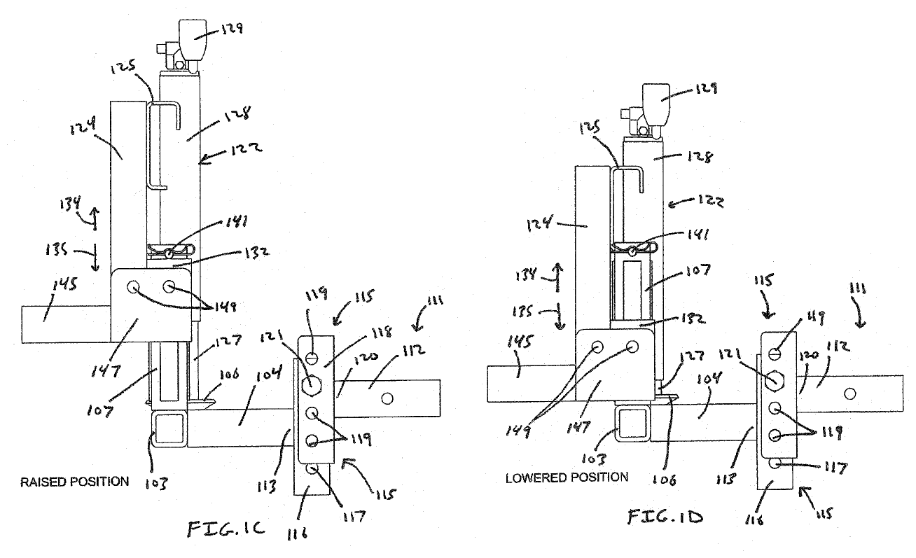

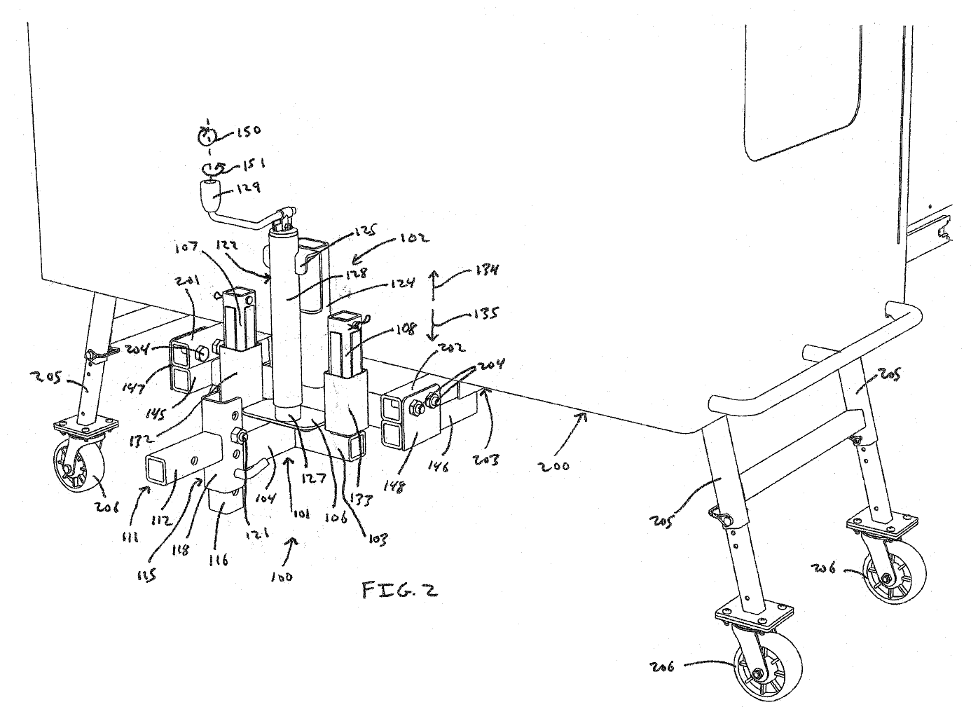

With reference now to FIGS. 1A-1D, a lifting device 100 according to one embodiment of the present disclosure includes a base assembly 101 and a lift assembly 102 movably coupled to the base assembly 101. In the illustrated embodiment, the base assembly 101 includes a base frame including a cross-beam or cross-member 103 extending transversely and an axial member 104 having a rear end 105 coupled to an intermediate portion (e.g., a middle) of the cross-member 103. In the illustrated embodiment, the cross-member 103 and the axial member 104 are arranged in a generally T-shaped configuration. In one or more embodiments, the base frame of the base assembly 101 may have any other suitable configuration, such as, for instance, a rectangular or square configuration (e.g., a window frame configuration). In the illustrated embodiment, the base assembly 101 also includes a base plate or platform 106 coupled to an upper end of the base frame (e.g., upper ends of the cross-member 103 and the axial member 104). In the illustrated embodiment, the platform 106 is located at a joint between the cross-member 103 and the axial member 104.

Furthermore, in the illustrated embodiment, the base assembly 101 includes a pair of guides or rails 107, 108 coupled to the cross-member 103 and extending upward from the cross-member 103. In the illustrated embodiment, the first guide or rail 107 is coupled to one end 109 of the cross-member 103 and the second guide or rail 108 is coupled to an opposite end 110 of the cross-member 103.

In the illustrated embodiment, the lifting device 100 also includes an auxiliary attachment assembly 111. In the illustrated embodiment, the auxiliary attachment assembly 111 is a hitch attachment assembly configured to connect the lifting device 100 to the hitch of a tow vehicle. In the illustrated embodiment, the hitch attachment assembly 111 includes a hitch bar 112 configured to be inserted into a receiver hitch of a vehicle. The hitch bar 112 is coupled to a forward end 113 of the axial member 104. In the illustrated embodiment, the hitch bar 112 includes a pair of openings 114 configured to align with a corresponding pair of openings in the receiver hitch of the vehicle and receive a pin extending through the aligned openings in the hitch bar 112 and the hitch receiver to secure the hitch attachment assembly 111 to the vehicle. In one or more embodiments, the auxiliary attachment assembly 111 may have any other suitable configuration depending on the configuration of the structure for which the lifting device 100 is designed to be attached.

Additionally, in the illustrated embodiment, the hitch attachment assembly 111 includes a height adjustment mechanism 115 to adjust the height of the lifting device 100 depending, for instance, on the height of the hitch receiver of the tow vehicle. In the illustrated embodiment, the height adjustment mechanism 115 includes a vertical post 116 defining a series of pairs of openings 117 coupled (e.g., directly coupled) to the forward end 113 of the axial member 104, and a bracket 118 defining a series of pairs of openings 119 coupled to a rear end 120 of the hitch bar 112. In the illustrated embodiment, the bracket 118 is a C-shaped bracket that extends partially around the vertical post 116, although in one or more embodiments the bracket 118 may have any other suitable shape for attachment to the vertical post 116. The height of the lifting device 100 may be selected by aligning one pair of the openings 119 in the bracket 118 with one pair of the openings 117 in the vertical post 116 and then inserting a fastener 121 through the aligned openings 117, 119. In one or more embodiments, a second fastener (e.g., a pin) may be inserted through a second set of aligned openings 117, 119 in the vertical post 116 and the bracket 118, respectively, to prevent the bracket 118 from rotating relative to the vertical post 116. In the illustrated embodiment, a maximum height of the lifting device 100 may be set by aligning the two uppermost rows of openings 119 in the bracket 118 with the two lowermost rows of openings 117 in the vertical post 116 and then inserting the fasteners 121 therethrough. A minimum height of the lifting device 100 may be set by aligning the two lowermost rows of openings 119 in the bracket 118 with the two uppermost rows of openings 117 in the vertical post 116 and then inserting the fasteners 121 therethrough.

In the illustrated embodiment, the lift assembly 102 includes a jack 122, a cross-member 123 extending transversely, a vertical support member 124 extending upward from an intermediate portion (e.g., a middle) of the cross-member 123 and aligned or substantially aligned with the jack 122, and a clip or bracket 125 coupled to the vertical support member 124 and supporting the jack 122. In the illustrated embodiment, the bracket 125 is generally C-shaped and includes one or more notches 126 configured to accommodate the jack 122 and thereby laterally support the jack 122. In one or more embodiments, the bracket 125 may have any other suitable configuration for supporting the jack 122 (e.g., providing lateral stability to the jack 122).

In the illustrated embodiment, the jack 122 includes an inner threaded screw 127, an outer sleeve 128 extending around at least a portion of the inner threaded screw 127, and a crank 129 rotatably coupled to an upper end 130 of the outer sleeve 128. A lower end 131 of the inner threaded screw 127 is coupled to the platform 106 of the base assembly 101. The platform 106 is configured to distribute loads transmitted through the jack 122 to both the cross-member 103 and the axial member 104 (e.g., loads transmitted through the jack 122 during use of the lifting device 100, such as lifting a trailer, are distributed by the platform 106 to the cross-member 103 and the axial member 104 of the base assembly 101. Although in the illustrated embodiment the jack 122 is a manual, screw-type jack, in one or more embodiments the jack 122 may be any other suitable type or kind of manual jack or the jack 122 may be a powered jack, such as a hydraulic, pneumatic, or electromechanical jack.

In the illustrated embodiment, the lift assembly 102 also includes a pair of sleeves or collars 132, 133 coupled to the cross-member 123. In the illustrated embodiment, the collars 132, 133 are oriented vertically or substantially vertically on the cross-member 123. The pair of collars 132, 133 is configured to slide up and down (arrows 134, 135, respectively) along the pair of guides 107, 108, respectively. In the illustrated embodiment, the first collar 132 is coupled to an intermediate portion of the cross-member 123 between the vertical support member 124 and a first outer end 136 of the cross-member 123, and the second collar 133 is coupled to an intermediate portion of the cross-member 123 between the vertical support 124 and a second outer end 137 of the cross-member 123 opposite the first outer end 136.

In the illustrated embodiment, each of the guides 107, 108 includes at least one projection 138 (e.g., at least one rib) and each of the collars 132, 133 includes at least one recess 139 (e.g., at least one groove or slot) configured to receive the projection 138 on the corresponding guide 107, 108. Although in the illustrated embodiment each of the guides 107, 108 includes four projections 138 and each of the collars 132, 133 includes four corresponding recesses 139, in one or more embodiments, the guides 107, 108 and the collars 132, 133 may include any other suitable number of corresponding projections 138 and recesses 139. Additionally, although in the illustrated embodiment the projections 138 are provided on the guides 107, 108 and the recesses 139 are provided in the collars 132, 133, in one or more embodiments the projections 138 may be provided in the collars 132, 133 and the recesses 139 may be provided in the guides 107, 108. The engagement between the collars 132, 133 and the guides 107, 108, and in one or more embodiments between the projections 138 and the recesses 139, is configured to maintain proper alignment between the lift assembly 102 and the base assembly 101 as the lifting device 100 is actuated to raise or lower the lift assembly 102 (e.g., the engagement between the collars 132, 133 and the guides 107, 108, and in one or more embodiments between the projections 138 and the recesses 139, is configured to mitigate against the lift assembly 102 tilting relative to the base assembly 101). Additionally, in one or more embodiments, the engagement between the collars 132, 133 and the guides 107, 108, and optionally between the projections 138 and the recesses 139, is configured to stabilize the lifting device 100 as the lifting device 100 is towed by a vehicle.

In the illustrated embodiment, an upper end 140 of each of the guides 107, 108 includes a fastener 141 (e.g., a bolt) extending through a pair of openings 142. Additionally, in the illustrated embodiment, the fastener 141 is retained by a cotter pin 143. The fasteners 141 at the upper ends 140 of the guides 107, 108 serve as stops preventing the collars 132, 133 from sliding off of the upper ends 140 of the guides 107, 108 and thereby limit the maximum height that the lift assembly 102 is configured to raise relative to the base assembly 101. In one or more embodiments, the guides 107, 108 may have any other suitable feature or features serving as stops preventing the collars 132, 133 from sliding off of the upper ends 140 of the guides 107, 108.

In the illustrated embodiment, the collars 132, 133 are square tubes and the guides 107, 108 are square posts. In one or more embodiments, the collars 132, 133 and the guides 107, 108 may have any other suitable corresponding shapes (e.g., the guides 107, 108 may be cylindrical rods and the collars 132, 133 may be cylindrical tubes configured to slide up and down along the cylindrical rods).

In the illustrated embodiment, the lift assembly 102 also includes second auxiliary attachment assembly 144. In the illustrated embodiment, the second auxiliary attachment assembly 144 is a trailer attachment assembly configured to connect the lifting device 100 to a trailer (e.g., extendable trailer) configured to be towed by the tow vehicle. In the illustrated embodiment, the trailer attachment assembly 144 includes a first axial member 145 coupled to the first outer end 136 of the cross-member 123 and a second axial member 146 coupled to the second outer end 137 of the cross-member 123. Additionally, in the illustrated embodiment, the trailer attachment assembly 144 includes a first bracket 147 coupled to an outer surface of the first axial member 145 and extending above the first axial member 145, and a second bracket 148 coupled to an outer surface of the second axial member 146 and extending above the second axial member 146. In the illustrated embodiment, the first and second brackets 147, 148 are flat plates, although in one or more embodiments the first and second brackets 147, 148 may have any other suitable configuration (e.g., an L-bracket). Furthermore, the first and second brackets 147, 148 each include at least one opening 149 (e.g., a pair of openings) configured to receive at least one fastener securing the brackets 147, 148 to the trailer or other structure that the lifting device 100 is intended to lift.

FIG. 2 depicts the embodiment of the lifting device 100 illustrated in FIGS. 1A-1D secured to a trailer 200 (e.g., an expandable trailer) configured to be towed by a vehicle. In the illustrated embodiment, the first and second axial members 145,146 of the trailer attachment assembly 144 are configured to align with first and second struts 201, 202 of a frame 203 coupled to an underside of the trailer 200 such that the first and struts 201, 202 of the trailer 200 are supported on the first and second axial members 145, 146, respectively, of the lifting device 100. Additionally, the first and second brackets 147, 148 of the trailer attachment assembly 144 are configured to overlap with the first and second struts 201, 202, respectively, in a lap joint configuration, and the openings 149 in the brackets 147, 148 are configured to align with openings in the struts 201, 202 of the frame 203. Furthermore, in the illustrated embodiment, the brackets 147, 148 of the lifting device 100 are secured to the frame 203 of the trailer 200 with fasteners 204 (e.g., bolts) extending through the openings 149 in the brackets 147, 148 and into the aligned openings in the struts 201, 202 of the frame 203.

In operation, the height of the trailer 200 off of the ground may be increased by rotating the crank 129 of the jack 122 in a first direction (arrow 150). As the crank 129 is rotated in the first direction (arrow 150), the outer sleeve 128 of the jack 122 slides upward (arrow 134) along the inner threaded screw 127 and the collars 132, 133 slide upward (arrow 134) along the guides 107, 108, respectively. As the collars 132, 133 slide upward along the guides 107, 108, the axial members 145, 146 of the trailer attachment assembly 144, which are connected to the collars 132, 133 by the cross-member 123 of the lift assembly 102, also move upward. The upward movement of the axial members 145, 146 of the trailer attachment assembly 144 raises the trailer 200 relative to the ground due to the engagement between the axial members 145, 146 and the struts 201, 202 of the frame 203 of the trailer 200. In one or more embodiments, the crank 129 may be rotated in the first direction (arrow 150) until the trailer 200 is sufficiently high off of the ground to permit legs 205 and wheels 206 coupled to an underside of the trailer 200 to move from a stowed position along the underside of the trailer 200 to a deployed position, shown in FIG. 2. For instance, in one or more embodiments, once the trailer 200 has been towed by the tow vehicle to the desired location, the lifting device 100 may be utilized to raise the trailer 200 and then the legs 205 and the wheels 206 on the ends of the legs 205 may be moved from the stowed position to the deployed position.

To lower the trailer, the crank 129 of the jack 122 may be rotated in a second direction (arrow 151) opposite the first direction. As the crank 129 is rotated in the second direction (arrow 151), the outer sleeve 128 of the jack 122 slides downward (arrow 135) along the inner threaded screw 127 and the collars 132, 133 slide downward along the guides 107, 108, respectively. As the collars 132, 133 slide downward along the guides 107, 108, the axial members 145, 146 of the trailer attachment assembly 144, which are connected to the collars 132, 133 by the cross-member 123 of the lift assembly 102, also move downward. The downward movement of the axial members 145, 146 of the trailer attachment assembly 144 lowers the trailer 200 relative to the ground due to the engagement between the axial members 145, 146 and the struts 201, 202 of the frame 203 of the trailer 200. In one or more embodiments, the crank 129 may be rotated in the second direction (arrow 151) until the legs 205 and/or the wheels 206 on the ends of the legs 205 are supported on the ground. Once the legs 205 and the wheels 206 have been moved into the deployed position and have been lowered onto the ground, the lifting device 100 may be unhitched from the tow vehicle (e.g., the hitch bar 112 may be disconnected from the receiver hitch of the tow vehicle).

When a user desired to relocate the trailer 200, the lifting device 100 may be utilized to sufficiently raise the trailer 200 such that the legs 205 and/or the wheels 206 may be returned to the stowed configuration. Once the legs 205 and/or the wheels 206 of the trailer 200 have been returned to the stowed configuration, the vehicle may be utilized to tow the trailer 200 to the desired location. In one or more embodiments, the lifting device 100 may be utilized to raise any other device or any other component of the device.

While this invention has been described in detail with particular references to exemplary embodiments thereof, the exemplary embodiments described herein are not intended to be exhaustive or to limit the scope of the invention to the exact forms disclosed. Persons skilled in the art and technology to which this invention pertains will appreciate that alterations and changes in the described structures and methods of assembly and operation can be practiced without meaningfully departing from the principles, spirit, and scope of this invention. Although relative terms such as “outer,” “inner,” “upper,” “lower,” and similar terms have been used herein to describe a spatial relationship of one element to another, it is understood that these terms are intended to encompass different orientations of the various elements and components of the invention in addition to the orientation depicted in the figures. Additionally, as used herein, the term “substantially,” “about,” and similar terms are used as terms of approximation and not as terms of degree, and are intended to account for the inherent deviations in measured or calculated values that would be recognized by those of ordinary skill in the art. Furthermore, as used herein, when a component is referred to as being “on” another component, it can be directly on the other component or components may also be present therebetween. Moreover, when a component is component is referred to as being “coupled” to another component, it can be directly attached to the other component or intervening components may be present therebetween.

What is claimed is:

1. A lifting device comprising:
a base assembly comprising:
a base frame; and
at least one guide extending upward from the base frame;
a hitch attachment assembly coupled to the base assembly, wherein the hitch attachment assembly is configured to connect to a hitch of a vehicle;
a lift assembly movably coupled to the base assembly, the lift assembly comprising:
a jack;
at least one sleeve coupled to the jack, the at least one sleeve being in slidable engagement with the at least one guide of the base assembly; and
a trailer attachment assembly coupled to the lift assembly, wherein the trailer attachment assembly is configured to connect to a trailer, and
wherein actuation of the jack is configured to raise or lower the lift assembly and the trailer attachment assembly relative to the base assembly and the hitch attachment assembly.

2. The lifting device of claim 1, wherein:
the at least one guide comprises a pair of guides on opposite sides of the jack; and
the at least one sleeve comprises a pair of sleeves in slidable engagement with the pair of guides.

3. The lifting device of claim 1, wherein the jack is selected from the group consisting of a manual screw-type jack, a hydraulic jack, a pneumatic jack, and an electromechanical jack.

4. The lifting device of claim 1, wherein the hitch attachment assembly further comprises a height adjustment mechanism.

5. The lifting device of claim 4, wherein the height adjustment mechanism comprises:
a vertical post defining a first plurality of openings;
a bracket configured to slide relative to the vertical post, the bracket defining a second plurality of openings configured to align with the first plurality of openings; and
at least one fastener configured to extend through aligned openings of the first and second plurality of openings in the vertical post and the bracket.

6. The lifting device of claim 1, wherein the hitch attachment assembly comprises a hitch bar.

7. The lifting device of claim 1, wherein:
the at least one guide of the base assembly comprises at least one recess; and
the at least one sleeve of the lift assembly comprises at least one projection extending into the at least one recess.

8. The lifting device of claim 1, wherein:
the at least one sleeve of the lift assembly comprises at least one recess; and
the at least one guide of the base assembly comprises at least at least one projection extending into the at least one recess.

9. The lifting device of claim 1, wherein the lift assembly further comprises:
a cross-member extending transversely;
a vertical support member extending upward from an intermediate portion of the cross-member; and
a bracket coupled to the vertical support member, the bracket supporting a portion of the jack.

10. The lifting device of claim 9, wherein the bracket is C-shaped, and wherein the bracket comprises at least one notch accommodating the portion of the jack.

11. The lifting device of claim 9, wherein the trailer attachment assembly comprises:
a first axial member coupled to a first outer end of the cross-member;
a first bracket coupled to the first axial member, the first bracket defining at least one first opening;
a second axial member coupled to a second outer end of the cross-member; and
a second bracket coupled to the second axial member, the second bracket defining at least one second opening,
wherein the first and second openings are configured to receive fasteners securing the trailer attachment assembly to the trailer.

12. The lifting device of claim 1, wherein the base frame comprises a cross-member and an axial member in a T-shaped configuration.

13. The lifting device of claim 12, wherein the base assembly further comprises a platform at a joint between the axial member and the cross-member.

14. The lifting device of claim 13, wherein the at least one guide comprises a first guide extending upward from a first end portion of the cross-member, and a second guide extending upward from a second end portion of the cross-member.

15. A lifting device configured to raise and lower a trailer relative to a hitch of a tow vehicle to which the trailer is connected, the lifting device comprising:
a base assembly comprising:
a cross-member;
an axial member coupled to the cross-member;
a platform at a joint between the cross-member and the axial member;
a first guide extending upward from a first end portion of the cross-member; and
a second guide extending upward from a second end portion of the cross-member;
a hitch attachment assembly coupled to the base assembly, the hitch attachment assembly comprising a hitch bar;
a lift assembly movably coupled to the base assembly, the lift assembly comprising:
a cross-member;
a vertical support member extending upward from an intermediate portion of the cross-member;
a jack coupled to the platform;
a bracket coupled to the vertical support member and supporting the jack;
a first sleeve coupled to the cross-member and in slidable engagement with the first guide;
a second sleeve coupled to the cross-member and in slidable engagement with the second guide; and
a trailer attachment assembly coupled to the cross-member of the lift assembly,
wherein actuation of the jack is configured to raise or lower the lift assembly and the trailer attachment assembly relative to the base assembly and the hitch attachment assembly.

16. The lifting device of claim 15, wherein the jack is selected from the group consisting of a manual screw-type jack, a hydraulic jack, a pneumatic jack, and an electromechanical jack.

17. The lifting device of claim 15, wherein the hitch attachment assembly further comprises a height adjustment mechanism, and wherein the hitch bar is coupled to the height adjustment mechanism.

18. The lifting device of claim 17, wherein the height adjustment mechanism comprises:
a vertical post defining a first plurality of openings;
a bracket configured to slide relative to the vertical post, the bracket defining a second plurality of openings configured to align with the first plurality of openings; and
at least one fastener configured to extend through aligned openings of the first and second plurality of openings in the vertical post and the bracket.

19. The lifting device of claim 15, wherein the trailer attachment assembly comprises:
a first axial member coupled to a first outer end of the cross-member;
a first bracket coupled to the first axial member, the first bracket defining at least one first opening;
a second axial member coupled to a second outer end of the cross-member; and
a second bracket coupled to the second axial member, the second bracket defining at least one second opening,
wherein the first and second openings are configured to receive fasteners securing the trailer attachment assembly to the trailer.
